(19) United States
(12) Patent Application Publication
(10) Pub. No.: US 2021/0012295 A1
(43) Pub. Date: Jan. 14, 2021

(54) Network-Based Certificiate Provisioning

(71) Applicant: Assured Performance Network, Laguna Hills, CA (US)

(72) Inventor: Scott Edwin Biggs, Polson, MT (US)

(21) Appl. No.: 16/506,984

(22) Filed: Jul. 9, 2019

(51) Int. Cl. G06Q 10/00; G06F 16/182; G07C 5/00; G07C 5/08

(52) U.S. Cl. CPC G06Q 10/20; G06F 16/1824; G07C 2205/02; G07C 5/0808; G07C 5/006

(57) ABSTRACT

Adequacy of a given repair of a given apparatus by a given entity at a given facility is remotely certified via an intervening communications network. By one approach, these teachings provide for determining a plurality of repair evaluation parameters, determining repair details for a particular repair of a given apparatus, and then comparing the foregoing against the latter to determine whether the repair details suitably accord with the repair evaluation parameters. When such is the case, these teachings provide for certifying the particular repair of the given apparatus as meeting certification standards.

### TECHNICAL FIELD

These teachings relate generally to network-based communications and more particularly to certificate administration via a communications network.

### BACKGROUND

As surely as things are made, things become broken. In many cases, broken things can be repaired. Proper repairs typically require, for example, the use of proper replacement parts. A considerable degree of uncertainty and/or (not necessarily well founded) trust often accompanies having a broken thing repaired because interested parties lack sufficient information regarding the repair and/or knowledge about how to interpret or to assess available information regarding the repair.

In some cases, such uncertainty and blind trust are insufficient and unsatisfactory. Such can be the case when, for example, responsibility for a given repair lies with someone other than the owner of the thing that is broken. Insurers and extended warranty providers can be very interested, for a variety of reasons, in ensuring that a given covered repair is correctly undertaken. Unfortunately, to some very large extent, “business as usual” in these regards simply falls back on trust that is founded only upon scanty facts and superficial evidence.

In addition, evaluating a given repair is often further confounded by a lack of credible and/or useful information regarding the parameters by which a given repair can be evaluated. As a result, even an evaluator who has access to at least some information regarding a particular repair may be unable to evaluate that repair in any useful objective manner.

### BRIEF DESCRIPTION OF THE DRAWINGS

The above needs are at least partially met through provision of the network-based certificate provisioning apparatus and method described in the following detailed description, particularly when studied in conjunction with the drawings, wherein:

FIG. 1 comprises a block diagram as configured in accordance with various embodiments of these teachings; and

FIG. 2 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are potentially not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments pertain to proving adequacy of a given repair of a given apparatus by a given entity at a given facility.

By one approach, these teachings provide for determining a plurality of repair evaluation parameters, determining repair details for a particular repair of a given apparatus, and then comparing the foregoing against the latter to determine whether the repair details suitably accord with the repair evaluation parameters. When such is the case, these teachings provide for certifying the particular repair of the given apparatus as meeting certification standards.

By one approach, determining the aforementioned repair evaluation parameters comprises identifying one or more of (1) at least minimum equipment and tools that are requisite to effect the particular repair of the given apparatus to thereby provide a listing of adequate equipment and tools; (2) at least minimum personal repair skills that are requisite to effect the particular repair of the given apparatus to thereby provide a listing of adequate repair skills; (3) at least minimum predetermined repair procedures that are requisite to effect the particular repair of the given apparatus to thereby provide a listing of adequate repair procedures; and (4) parts that should be utilized to effect the particular repair of the given apparatus as well as previously-approved sources (i.e., manufacturing sources or distributor sources as desired) for the identified parts to thereby provide a listing of adequate parts and corresponding sources.

By one approach, in lieu of the foregoing or in combination therewith, determining the repair details for the particular repair of the given apparatus comprises identifying one or more of (1) parts actually utilized to effect the particular repair of the given apparatus and corresponding actual sources for the utilized parts; (2) personnel utilized to effect the particular repair of the given apparatus and corresponding repair qualifications for those personnel; (3) equipment and tools corresponding to the particular repair that the given entity had available to it at the given entity; and (4) repair procedures utilized and observed to effect the particular repair of the given apparatus.

By one approach a control circuit serves, in whole or in part, to determine the aforementioned repair evaluation parameters and/or the aforementioned repair details for the particular repair of the given apparatus. By one approach, in lieu of the foregoing or in combination therewith, the control circuit conducts the aforementioned comparison of the repair details to the corresponding repair evaluation parameters to assess and determine a requisite level of minimal equivalence therebetween.

By one approach, these teachings provide for determining the aforementioned repair details by, at least in part, receiving information provided by the given entity via a corresponding communication network. This information can include, for example, images relevant to the particular repair, communications links corresponding to training received by the personnel utilized to effect the particular repair of the given apparatus, and/or information regarding on-board diagnostic codes from the given apparatus (such as, for example, information evidencing that all relevant on-board diagnostic codes were cleared following the repair).

So configured, these teachings present a network-based evidentiary approach to assessing and confirming that a particular repair of a particular apparatus was undertaken while observing proper repair procedures by personnel who were adequately trained and who had appropriate tools and equipment available, using appropriate (and appropriately-sourced) parts. The provided evidence can include information obtained pre-repair, during the repair, and post-repair that confirms the adequacy of the repair.

By one approach, the result of the foregoing assessment can be a certification that the particular repair of the given apparatus meets the foregoing standards. This certification can be provided to one or more interested parties. By one approach, the certification can be provided via a corresponding communications network.

To a very large extent, these teachings can be implemented in a manner that avoids on-site inspection by one or more third-party observers on a repair-by-repair basis. These teachings can also avoid requiring the repaired apparatus be delivered to an off-site and/or third-party facility to undergo a post-repair inspection to assure the adequacy of the repair. These teachings can also be undertaken by the repair facility in an intuitive and noninvasive manner that avoids imposing undue reporting and/or additional paperwork requirements, thus avoiding increasing overhead costs and hence the cost of repair. These teachings also eschew a more generalized approach where a given repair facility is given a general inspection and certification that is not tied to any specific and particular repair event.

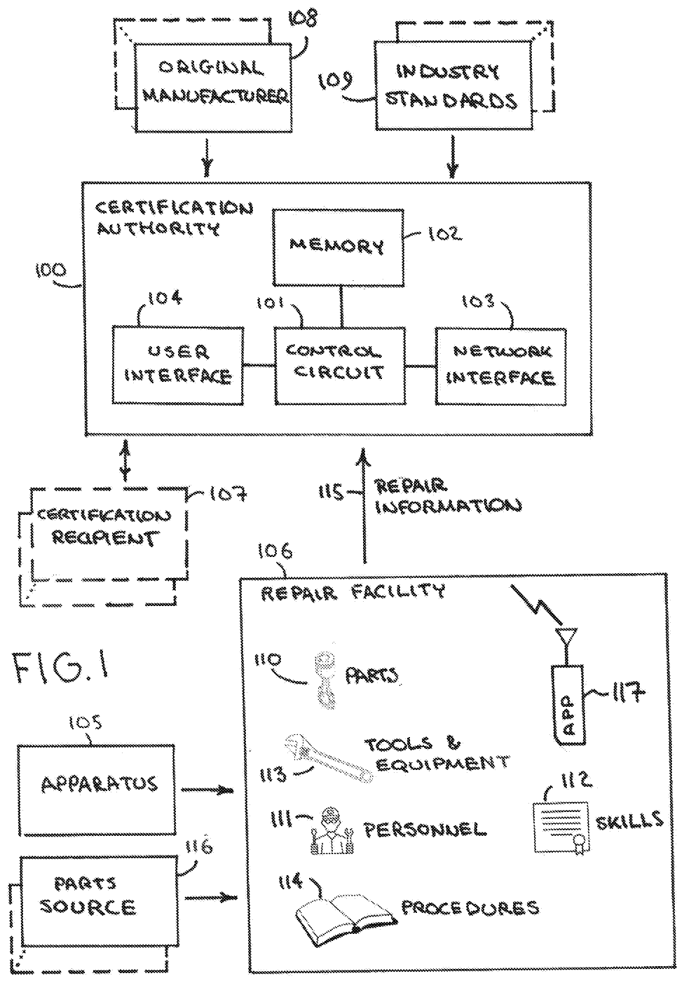

These and other benefits may become clearer upon making a thorough review and study of the following detailed description. Referring now to the drawings, and in particular to FIG. 1, an illustrative platform that is compatible with many of these teachings will now be presented.

As shown in FIG. 1, a certification authority 100 can include a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach, the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to the repair evaluation parameters and repair details information described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as a dynamic random access memory (DRAM).)

In this example, the control circuit 101 also operably couples to a network interface 103. So configured the control circuit 101 can communicate with other elements (both within the platform 100 and external thereto) via the network interface 103. Network interfaces, including both wireless and non-wireless platforms, are well understood in the art and require no particular elaboration here. That said, a non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi™-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces, to note but a few.

Also in this example, the control circuit 101 operably couples to a user interface 104. This user interface 104 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

When configured as described herein, this certification authority 100 can serve to certify, on a repair-by-repair basis, the particular repair of a given apparatus 105 by a particular repair facility 106 to one or more certification recipients 107 as meeting certification standards that can include a variety of credibly-sourced parameters. These teachings are highly flexible in practice and will accommodate a wide variety of apparatuses 105. Examples include but are not limited to powered terrestrial vehicles (such as automobiles, trucks and vans, tractors, motorcycles, motor-augmented bicycles and scooters, and so forth), aerospace vehicles, marine vehicles, manually-powered vehicles, autonomously-piloted vehicles, and remotely-piloted vehicles, to note but a few examples. For the sake of an illustrative example, the remainder of this descriptive example will presume that the apparatus 105 comprises a powered terrestrial vehicle and in particular an automobile.

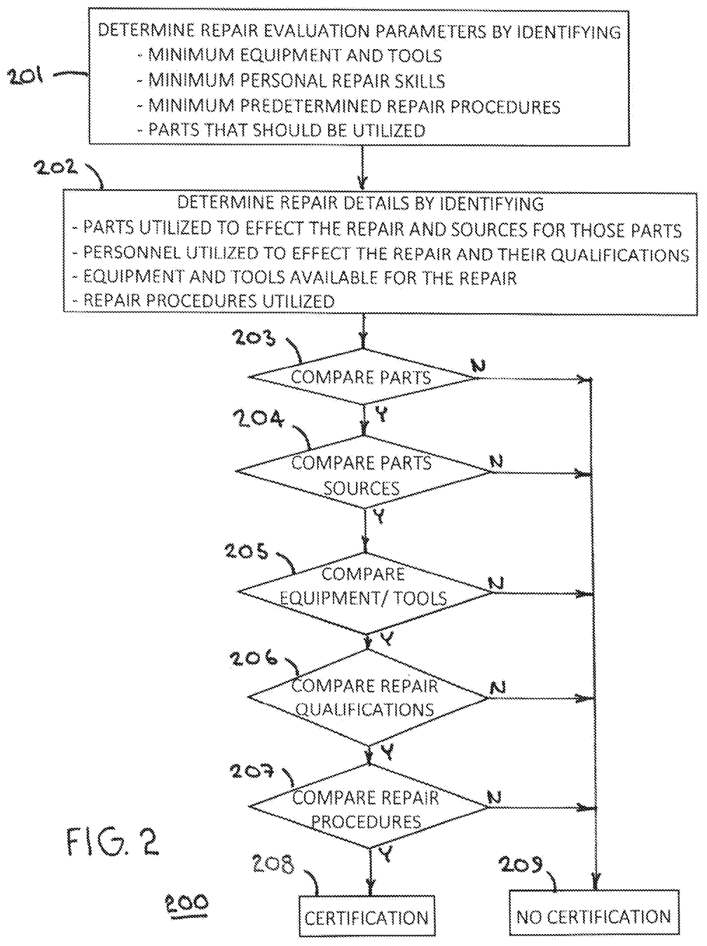

Referring now to both FIGS. 1 and 2, the aforementioned control circuit 101 can serve as desired to facilitate or to conduct any one of a plurality of steps and/or comparisons presented in FIG. 2. In many application settings, the volume of repairs requiring certification, in combination with the relative thoroughness and complexity of this certification process, will necessitate the use of the control circuit 101 in such regards in order to ensure timely (as well as objectively accurate) certification results.

At block 201, this process 200 provides for determining each of a plurality of repair evaluation parameters pertaining to the apparatus 105. The illustrated process 200 provides for determining such repair evaluation parameters for a number of specific repair categories. As a first example in these regards, this process 200 provides for determining repair evaluation parameters by identifying at least minimum equipment and tools that are requisite to effect the particular repair of the given apparatus 105 to provide a listing of adequate equipment and tools. Generally speaking, “tools” refers to hand tools while “equipment” refers to facility infrastructure (such as a vehicle hydraulic lift). By one approach, such information can be provided by at least one of an original manufacturer 108 of the given apparatus 105 and a relevant industry-standard 109 (for example, as promulgated and/or as maintained or publicized by a relevant industry trade group or standards body). Such information regarding tools and equipment can be at least partially specific to the given apparatus 105 itself, the nature of the repair at issue, and/or the nature and specifics of any required or anticipated replacement parts, and/or may be at least generally representative of tools and equipment that should generally be available when effecting repairs on apparatuses that are categorically similar to the apparatus 105.

As a second example in these regards, this process 200 provides for determining repair evaluation parameters by identifying at least minimum personal repair skills that are requisite to effect the particular repair of the given apparatus to provide a listing of adequate repair skills. By one approach such information can be provided by at least one of an original manufacturer 108 of the given apparatus 105 and a relevant industry-standard 109 (for example, as promulgated and/or maintained or publicized by a relevant industry trade group or standards body). Such information regarding personal repair skills can be at least partially specific to the given apparatus 105 itself, the nature of the repair at issue, and/or the nature and specifics of any required or anticipated replacement parts, and/or may be at least generally representative of personal repair skills that should generally be available when effecting repairs on apparatuses that are categorically similar to the apparatus 105. By one approach, the information identified can include specific training programs, academic degrees, and/or certifications provided by specific or categorically-approved (by the certification authority 100) training/education programs/services.

As a third example in these regards, this process 200 provides for determining repair evaluation parameters by identifying at least minimum predetermined repair procedures that are requisite to effect the particular repair of the given apparatus 105 to provide a listing of adequate repair procedures. By one approach, such information can again be provided by at least one of an original manufacturer 108 of the given apparatus 105 and a relevant industry-standard 109 (for example, as promulgated and/or maintained or publicized by a relevant industry trade group or standards body). Such information regarding predetermined repair procedures can be at least partially specific to the given apparatus 105 itself, the nature of the repair at issue, and/or the nature and specifics of any required or anticipated replacement parts, and/or may be at least generally representative of predetermined repair procedures that should generally be observed and followed when effecting repairs on apparatuses that are categorically similar to the apparatus 105.

And as a fourth example in these regards, this process 200 provides for determining repair evaluation parameters by identifying parts that should be utilized to effect the particular repair of the given apparatus 105 as well as previously-approved sources for the identified parts to provide a listing of approved parts and their respective sources. By one approach, such information can again be provided by at least one of an original manufacturer 108 of the given apparatus 105 and a relevant industry-standard 109 (for example, as promulgated and/or maintained or publicized by a relevant industry trade group or standards body). Such information regarding parts and sources can be at least partially specific to the given apparatus 105 itself, the nature of the repair at issue, and/or the nature and specifics of any required or anticipated replacement parts, and/or may be at least generally representative of parts and sources that should generally be observed and followed when effecting repairs on apparatuses that are categorically similar to the apparatus 105.

These teachings are highly flexible in practice. As one example in these regards, these teachings will accommodate identifying alternatives with respect to any of the repair evaluation parameters so identified. By way of illustration, there may be two or more recognized valid-yet-different predetermined repair procedures to effect a given repair on the given apparatus 105. Although this process 200 could be configured to select only one of these predetermined repair procedures as being “best” to the exclusion of any other identified possibility, these teachings will also accommodate treating multiple such procedures as all being valid and hence effectively equal to one another in terms of their permitted use.

At block 202, this process 200 determines repair details for the particular repair of the given apparatus 105. The illustrated process 200 provides for determining such repair details for a number of specific categories. As a first example in these regards, this process 200 provides for determining repair details for the particular repair of the given apparatus 105 by identifying parts 110 that were utilized to effect the particular repair of the given apparatus 105. In these same regards, this activity also includes identifying the corresponding sources 116 for the utilized parts 110. (By one approach, all utilized parts are identified. By another approach, certain specific or categorical parts might be exempted from consideration as specified by the certification authority 100.)

In some cases, a part 110 may be identified by the name of the manufacturer and/or distributor along with a model and/or serial number. In other cases, a part 110 may be identified by a more categorical representation (such as a particular weight for motor oil in conjunction with a brand name or manufacturer name). These teachings will accommodate other approaches in these regards as well.

As a second example in these regards, this process 200 provides for determining repair details for the particular repair of the given apparatus 105 by identifying the personnel 111 that were utilized to effect the particular repair of the given apparatus 105. In these same regards, this activity also includes identifying the corresponding repair qualifications (i.e., skills 112) for such personnel 111.

As a third example in these regards, this process 200 provides for determining repair details for the particular repair of the given apparatus 105 by identifying the tools and equipment 113 corresponding to the particular repair that the given entity (i.e., the repair facility 106) had available to it at the repair facility 106 during the repair of the given apparatus 105. By one approach, this determination can comprise identifying the specific tools (either categorically (such as by a generic tool name) and/or by some meaningful or unique identifier (such as by a model number or serial number)) that were actually employed during the repair activity.

And as a fourth example in these regards, this process 200 provides for determining repair details for the particular repair of the given apparatus 105 by identifying the repair procedures 114 that were utilized to effect the particular repair of the given apparatus 105. By one approach, this activity can comprise obtaining a narrative, check list, or other literal description of the procedure. By another approach, in lieu of the foregoing or in combination therewith, this activity can comprise specifying a representative identifier for a particular pre-identified procedure (as provided, for example, in a repair procedure publication provided by the original manufacturer 108).

These teachings will accommodate other approaches in these regards as well. For example, the repair information 115 provided by the repair facility 106 to the certification authority 100 may include one or more streaming videos and/or video files that provide a view of part or all of the repair of the apparatus 105. In such a case, artificial intelligence could be employed by the control circuit 101 to assess the video content and to identify particular procedural steps in the repair process to thereby develop a non-video description of the repair procedure to serve as the identified repair procedure contemplated herein.

The aforementioned repair details can be provided to the certification authority 100 using any of a variety of content-conveying modalities. When the content comprises, at least in part, alphanumeric text, the content can be pushed to the certification authority (on a scheduled or unscheduled basis as desired) and/or pulled by the certification authority when needed. By one approach, such content can be formulated by the repair facility 106 and then transmitted as repair information 115 to the certification authority 100. As one illustrative example in these regards, the repair facility 106 can complete a form provided by the certification authority 100 that gleans the necessary information. By another approach, the repair facility 106 can access an online content-entry point (such as a website) provided by or on behalf of the certification authority 100. The appropriate information can then be entered, either as free text or as answers or entries to questions provided to elicit the appropriate responses.

By another approach, in lieu of the foregoing or in combination therewith, the repair information 115 can include one or more images relevant to the particular repair. These can be still images and/or video images. The images can provide views of the repair activity at various stages of the repair. Such images can also provide views of replaced parts and replacement parts, utilized and/or available tools and equipment, the relevant repair personnel (including, for example, images of their faces to thereby facilitate facial recognition by the control circuit 101), and/or evidence of their training accomplishments (such as images of their training certificates and academic achievements), and so forth.

By one approach, the repair information 115 can also include information regarding on-board diagnostic codes (such as but not limited to OBD diagnostic codes, EOBD diagnostic codes, JOBD diagnostic codes, and so forth as are well known and understood in the art) from the given apparatus 105. This can include all flagged diagnostic codes offered by the apparatus 105 prior to effecting the repair and/or any diagnostic codes still being triggered by the apparatus 105 subsequent to the repair. By one approach in these regards, the repair information 115 can comprise information confirming that all relevant (to the repair) on-board diagnostic codes stand consistently cleared following the repair.

Communication links can also be utilized to convey repair information 115 to the certification authority 100. By one approach, the repair facility 106 can upload its repair information 115 to, for example, a cloud-based repository. In this case, the repair facility 106 can then provide a corresponding communication link (such as a relevant uniform resource locator (URL)) in the repair information 115. The certification authority 100 can then assert that link in order to access and retrieve the uploaded repair information 115. By another approach, the provided communication link can lead to a relevant third-party source. For example, an education or training entity may maintain a link that identifies specific training, education, and/or certification that a particular person has achieved. Such a link can be provided in the repair information 115 as evidence of a particular repair person's qualifications.

By one approach, some or all of the repair information 115 can be conveyed to the certification authority 100 via a corresponding dedicated app on a mobile communication device 117 (such as a so-called smart phone or pad/tablet-style computer). Such an app can utilize the device's user interface to permit the user to enter and/or select repair information to be provided to the certification authority 100. The app can also make use of one or more cameras that are native to the device 117 to capture the aforementioned image content. Such an app can also make use of the device's microphone to permit the user to add verbal repair information 115 if desired (such as, for example, a narration of the repair procedure rendered live during the course of the procedure).

Being possessed of the aforementioned repair evaluation parameters and repair details for the particular repair of the given apparatus 105 by the repair facility 106, the certification authority 100 now conducts a plurality of comparisons 203-207 in order to determine that appropriate parts from appropriate sources were used, that the repair facility 106 had proper equipment and tools available, that the personnel utilized to effect the repair were properly qualified, and that adequate repair procedures were employed to effect the repair.

In particular, at block 203 this process 200 provides for comparing the parts 110 utilized to effect the particular repair of the given apparatus 105 against the listing of adequate parts to determine whether appropriate parts were used to effect the particular repair of the given apparatus 105. At block 204, this process 200 provides for comparing the sources 116 for the parts 110 utilized to effect the particular repair of the given apparatus 105 against the listing of previously-approved sources to determine whether the parts were appropriately sourced. At block 205, this process 200 provides for comparing the equipment and tools 113 that the repair facility 106 had available to it at the given entity against the listing of adequate equipment and tools to determine whether the repair facility 106 had proper equipment and tools available when effecting the particular repair of the given apparatus 105. At block 206, this process 200 provides for comparing the corresponding repair qualifications 112 for the personnel 111 utilized to effect the repair against the listing of adequate repair skills to determine whether the personnel 111 utilized to effect the particular repair of the given apparatus 105 were properly qualified. And at block 207, this process 200 provides for comparing the repair procedures 114 utilized to effect the particular repair against the listing of adequate repair procedures to determine whether adequate repair procedures were employed to effect the particular repair of the given apparatus 105.

When all of the foregoing comparisons yield a positive result, this process 200 provides for responsively certifying, at block 208, this particular repair of the given apparatus 105 as meeting applicable evaluation standards. Should any of the foregoing comparisons yield a negative result, this process 200 ultimately concludes, at block 209, with a lack of certification.

These certification results (or lack of certification results) can be communicated to one or more certification recipients 107. Example recipients might include the apparatus owner, an insurer, an extended warranty provider, the repair facility 106 itself, the original manufacturer 108, and so forth. The certification can be as brief or as detailed as desired. By one approach, the certification can include details regarding the aforementioned repair evaluation parameters and the actual repair details. When providing repair details, the information can include part or all of the actual corroborating evidence provided by the repair facility 106 as described above. The certification results can be communicated via a written hard copy communication, email or other electronic transmission modality, a voice message, or otherwise as desired. As another example in these regards, the certification result can be uploaded to, for example, a cloud-based repository in which case a corresponding link can be sent to the certification recipient 107 to provide the recipient 107 with access to that result.

So configured, a considerable evidence-based improvement is achieved with respect to objectively assuring the integrity of a given repair to a given apparatus. The teachings provided herein go considerably further than present trust-based processes in these regards. At the same time, complying with these teachings does not present an undue burden upon a typical repair facility. Accordingly, these teachings represent a cost-effective solution. Those skilled in the art will also appreciate that certification can be completed in a relatively short period of time once the repair evaluation parameters and the repair details are available, especially when automatically processed by the control circuit 101.

Those skilled in the art will recognize that a wide variety of modifications, alterations, and combinations can be made with respect to the above described embodiments without departing from the scope of the invention, and that such modifications, alterations, and combinations are viewed as being within the ambit of the inventive concept. As but one example in these regards, the foregoing process can further include storing at least some information regarding the particular repair of the given apparatus in conjunction with an identifier for the given apparatus. By one approach, the identifier for the given apparatus can comprise a Vehicle Identification Number (VIN) for a terrestrial vehicle such as an automobile or truck. By one approach such information can be stored in a public ledger such as a blockchain-based data store.

What is claimed is:

1. A method pertaining to proving procedural adequacy of a repair of a given apparatus by a given entity at a given facility, the method comprising, as regards effecting a particular repair of the given apparatus:
determining repair evaluation parameters by identifying:
at least minimum equipment and tools that are requisite to effect the particular repair of the given apparatus to provide a listing of adequate equipment and tools;
at least minimum personal repair skills that are requisite to effect the particular repair of the given apparatus to provide a listing of adequate repair skills;
at least minimum predetermined repair procedures that are requisite to effect the particular repair of the given apparatus to provide a listing of adequate repair procedures; and
parts that should be utilized to effect the particular repair of the given apparatus and previously-approved sources for the identified parts to provide a listing of adequate parts and corresponding sources;
determining repair details for the particular repair of the given apparatus by identifying:
parts utilized to effect the particular repair of the given apparatus and corresponding sources for the utilized parts;
personnel utilized to effect the particular repair of the given apparatus and corresponding repair qualifications for the personnel;
equipment and tools corresponding to the particular repair that the given entity had available to it at the given entity; and
repair procedures utilized to effect the particular repair of the given apparatus; comparing:
the parts utilized to effect the particular repair of the given apparatus against the listing of adequate parts and corresponding sources to determine whether appropriate parts were used to effect the particular repair of the given apparatus;
the sources of the parts utilized to effect the particular repair of the given apparatus against the listing of adequate parts and corresponding sources to determine whether the parts used to effect the particular repair of the given apparatus were properly sourced;
the equipment and tools that the given entity had available to it at the given entity against the listing of adequate equipment and tools to determine whether the given entity had proper equipment and tools available when effecting the particular repair of the given apparatus;
the corresponding repair qualifications for the personnel utilized to effect the particular repair of the given apparatus against the listing of adequate repair skills to determine whether the personnel utilized to effect the particular repair of the given apparatus were properly qualified; and
the repair procedures utilized to effect the particular repair of the given apparatus against the listing of adequate repair procedures to determine whether adequate repair procedures were employed to effect the particular repair of the given apparatus; and
upon determining that appropriate parts were used to effect the particular repair of the given apparatus, that the parts used to effect the particular repair of the given apparatus were properly sourced, that the given entity had proper equipment and tools available when effecting the particular repair of the given apparatus, that the personnel utilized to effect the particular repair of the given apparatus were properly qualified, and that adequate repair procedures were employed to effect the particular repair of the given apparatus, certifying the particular repair of the given apparatus as meeting certification standards.

2. The method of claim 1 wherein the comparing comprises employing a control circuit to automatically conduct the comparing.

3. The method of claim 2 wherein the determining repair details for the particular repair of the given apparatus comprises using the control circuit to determine the repair details for the particular repair of the given apparatus.

4. The method of claim 1 wherein determining the repair evaluation parameters by identifying at least minimum equipment and tools that are requisite to effect the particular repair of the given apparatus comprises accessing information regarding the at least minimum equipment and tools as provided by at least one of an original manufacturer of the given apparatus and a relevant industry standard.

5. The method of claim 1 wherein determining the repair evaluation parameters by identifying at least minimum personal repair skills that are requisite to effect the particular repair of the given apparatus comprises accessing information regarding the at least minimum personal repair skills as provided by at least one of an original manufacturer of the given apparatus and a relevant industry standard.

6. The method of claim 1 wherein determining the repair evaluation parameters by identifying at least minimum predetermined repair procedures that are requisite to effect the particular repair of the given apparatus comprises accessing information regarding the at least minimum predetermined repair procedures as provided by at least one of an original manufacturer of the given apparatus and a relevant industry standard.

7. The method of claim 1 wherein determining the repair evaluation parameters by identifying parts that should be utilized to effect the particular repair of the given apparatus comprises accessing information regarding the parts that should be utilized to effect the particular repair of the given apparatus as provided by at least one of an original manufacturer of the given apparatus and a relevant industry standard.

8. The method of claim 1 wherein determining the repair details for the particular repair of the given apparatus comprises, at least in part, receiving information provided by the given entity.

9. The method of claim 8 wherein the information provided by the given entity comprises images relevant to the particular repair.

10. The method of claim 8 wherein receiving the information provided by the given entity comprises, at least in part, receiving information regarding on-board diagnostic codes from the given apparatus.

11. The method of claim 10 wherein certifying the particular repair of the given apparatus as meeting certification standards further comprises confirming that all relevant on-board diagnostic codes are cleared.

12. The method of claim 8 wherein receiving the information provided by the given entity comprises, at least in part, receiving communications links corresponding to training received by the personnel utilized to effect the particular repair of the given apparatus.

13. The method of claim 1 wherein the given apparatus comprises a powered terrestrial vehicle.

14. The method of claim 1 wherein the given apparatus comprises at least one of:
an aerospace vehicle;
a marine vehicle;
a manually-powered vehicle;
an autonomously-piloted vehicle;
a remotely-piloted vehicle.

15. The method of claim 1 further comprising:
storing at least some information regarding the particular repair of the given apparatus in conjunction with an identifier for the given apparatus.

16. The method of claim 15 wherein the identifier for the given apparatus comprises a Vehicle Identification Number (VIN) for a terrestrial vehicle.

17. The method of claim 15 wherein storing the at least some information regarding the particular repair of the given apparatus in conjunction with an identifier for the given apparatus comprises storing the at least some information regarding the particular repair of the given apparatus in conjunction with the identifier in a public ledger.

18. The method of claim 17 wherein the public ledger comprises a blockchain-based data store.
